(19) United States
(12) Patent Application Publication
(10) Pub. No.: US 2025/0375951 A1
(43) Pub. Date: Dec. 11, 2025

(54) ROOFING UNDERLAY WITH WATERPROOFING

(71) Applicant: Veer Corporations Inc., Tomball, TX (US)

(72) Inventors: Harjeev SINGH, Ghandhinagar (IN); Mark HINTERLONG, Tomball, TX (US)

(21) Appl. No.: 18/904,075

(22) Filed: Oct. 1, 2024

(30) Foreign Application Priority Data
Jun. 6, 2024 (IN) 202411043768

(51) Int. Cl. B32B 5/02; B32B 3/30; B32B 5/26; B32B 7/02; B32B 27/12; B32B 27/32; B32B 37/24; B32B 38/00; D04H 3/007; D04H 3/03; E04D 12/00

(52) U.S. Cl. CPC B32B 5/022; B32B 3/30; B32B 5/267; B32B 7/02; B32B 27/12; B32B 27/32; B32B 37/24; B32B 38/0012; D04H 3/007; D04H 3/03; E04D 12/002; B32B 2037/243; B32B 2255/02; B32B 2255/26; B32B 2262/0253; B32B 2305/20; B32B 2307/718; B32B 2307/7265; B32B 2307/7376; B32B 2307/744; B32B 2323/10; B32B 2419/06; D10B 2505/20

(57) ABSTRACT

A roofing underlay with a nail-sealable waterproof membrane and method of manufacturing the roofing underlay are described. The roofing underlay includes a main layer formed of a fibrous non-woven material including a plurality of continuous randomly oriented entangled fibers. An anti-slip layer and an anti-skid layer are bonded to the main layer. The main layer is compressed between the anti-slip layer and the anti-skid layer to create a nail-sealable waterproof membrane via capillary action of the continuous randomly oriented entangled fibers of the main layer.

### FIELD OF THE INVENTION

This disclosure relates generally to an underlay for a roofing structure and more particularly to a roofing underlay configured to provide waterproofing, such as to provide nail-sealability.

### BACKGROUND

Underlays for roofing structures are typically positioned between a roofing substrate and a roofing overlay, such as shingles, to protect against moisture and other elements which may pass under the overlay. Water seepage can occur, for example, at a nail that extends through the roofing underlay. Water can penetrate the roofing underlay through the nail and deteriorate the entire roofing structure assembly. Some conventional underlays add asphalt, tar, or synthetic adhesive products to provide some protection against water seepage. However, these conventional underlays with these added products are costly, heavy, difficult to handle during repairs, and negatively impact the environment. Also, over time, the asphalt or adhesive of these conventional underlays harden and lose nail-sealability, and often become slippery, thereby creating a hazard for roof installers.

### SUMMARY

The present disclosure may provide a roofing underlay that may comprise a main layer formed of a fibrous non-woven material that may comprise a plurality of continuous randomly oriented entangled fibers. An anti-slip layer can be bonded to a first surface of the main layer. The anti-slip layer may comprise an anti-slip surface. An anti-skid layer can be bonded to a second surface of the main layer. The anti-skid layer may comprise anti-skid additives. The main layer may be compressed between the anti-slip layer and the anti-skid layer to create a nail-sealable waterproof membrane via capillary action of the continuous randomly oriented entangled fibers of the main layer.

In certain aspects of the present disclosure, the fibrous non-woven material can be a thermoplastic non-woven fabric; the thermoplastic non-woven fabric can be an embossed double beam polypropylene spunbond fabric; a thickness of the main layer can be at least about 180 microns; a thickness of the main layer can be about 75-80% of an entire thickness of the roofing underlay; and/or the plurality of continuous randomly oriented entangled fibers of the main layer are configured to grip a nail extended therethrough.

In another aspect of the present disclosure, the underlay can comprise a bonding layer between the anti-slip layer and the first surface of the main layer. The bonding layer can be a polymeric coating, for example.

In yet other aspects of the present disclosure, the roofing underlay is devoid of adhesive; the roofing underlay is devoid of asphalt; and/or the roofing underlay is about 245 to 360 grams per square meter (GSM).

The present disclosure may provide a roofing underlay that may comprise a main layer formed of a fibrous non-woven fabric that may comprise a plurality of continuous randomly oriented entangled fibers. The main layer may have a first surface, a second surface, and a thickness that may be at least about 180 microns. An anti-slip layer may be formed of an embossed fabric that may comprise an anti-slip surface. The anti-slip layer may be bonded to the first surface of the main layer by a bonding layer that can be a lamination coating. An anti-skid layer may comprise anti-skid additives and can be applied to the second surface of the main layer. The main layer can be compressed between the anti-slip layer and the anti-skid layer to create a nail-sealable waterproof membrane via capillary action of the continuous randomly oriented entangled fibers of the main layer.

In some aspects of the present disclosure, the fibrous non-woven fabric can be an embossed double beam polypropylene spunbond fabric; the roofing underlay can be devoid of adhesive or asphalt; and/or the anti-skid layer can be configured to engage a roofing substrate and the anti-slip layer is configured to engage a roofing overlay.

The present disclosure may also provide a method of manufacturing a roofing underlay that may comprise extruding a polymer source material to form continuous filaments of polymeric material that forms a main layer in which the continuous filaments are oriented in a random manner; laminating an anti-slip layer to a first surface of the main layer, the anti-slip layer comprising an anti-slip surface; coating an anti-skid layer to a second surface of the main layer, the anti-skid layer comprising an anti-skid additives; and compressing the main layer between the anti-slip layer and the anti-skid layer to create a nail-sealable waterproof membrane via capillary action of the continuous randomly oriented entangled fibers of the main layer.

In an aspect of the method, forming the main layer can include cooling and stretching the filaments before orienting the filaments in a random manner. In an aspect, the method may comprise laminating the anti-slip layer on the main layer and coating the anti-skid layer to the main layer are done substantially simultaneously.

In other aspects of the method, the polymer source material can be polypropylene and the polymeric material can be an embossed double beam polypropylene spunbond fabric; the main layer can have a thickness of at least about 180 microns; and/or the roofing underlay is made such that the underlay is devoid of adhesive or asphalt.

This summary is not intended to identify essential features of the claimed subject matter, nor is it intended for use in determining the scope of the claimed subject matter. It is to be understood that both the foregoing general description and the following detailed description are exemplary and are intended to provide an overview or framework to understand the nature and character of the disclosure.

### BRIEF DESCRIPTION OF THE FIGURES

The accompanying drawings are incorporated in and constitute a part of this specification. It is to be understood that the drawings illustrate only some examples of the disclosure and other examples or combinations of various examples that are not specifically illustrated in the figures may still fall within the scope of this disclosure. Examples will now be described with additional detail through the use of the drawings, in which:

FIG. 1 is an enlarged partial cross-sectional view of an exemplary roofing underlay according to the present disclosure, showing the roofing underlay between a roofing substrate and a roofing overlay;

FIG. 2 is a perspective view of a portion of the roofing underlay illustrated in FIG. 1, showing the roofing underlay fastened to a roofing substrate;

FIG. 3 is a perspective view of an exemplary main layer of the roofing underlay illustrated in FIG. 1;

FIG. 4 is a flow chart of an exemplary method of manufacturing a roofing underlay according to the present disclosure; and

FIG. 5 is a partial top perspective view of a roofing structure of a building structure, showing the roofing underlay illustrated in FIG. 1 being installed onto the roofing substrate of the roofing structure.

### DETAILED DESCRIPTION

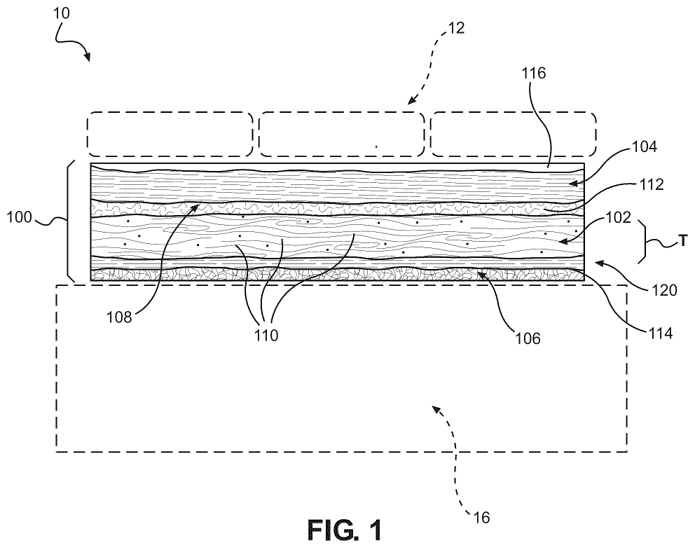

Referring to the figures, the present disclosure generally relates to a roofing underlay 100 of a roofing structure 10 that may be designed to hold onto water around a fastener, such as a nail, (also referred to herein as nail-sealability). Underlay 100 can be used with all types of roofing overlays 12 (FIG. 1) resulting in improved integrity and aesthetics of the roofing structure 10. Underlay 100 may be designed to have waterproofing (also referred to herein as “nail-sealability”) while also being lightweight with improved strength to provide ease of laying, operation, and maintenance thereof, and to be environmentally friendly. Underlay 100 provides nail-sealability performance along with anti-slip characteristics without any adhesive or asphalt coating and the inherent disadvantages of those materials.

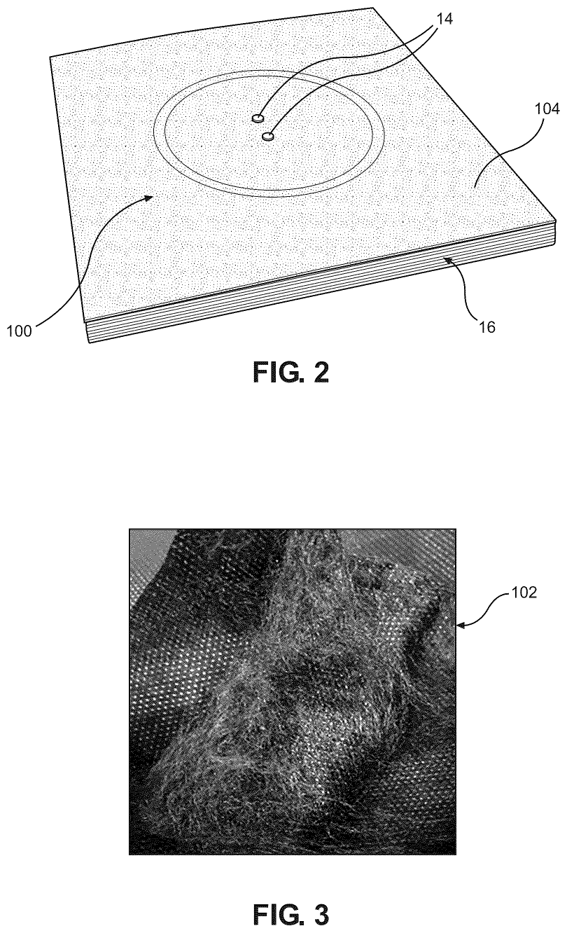

Underlay 100 may be configured to have nail-sealability, that is water sealability around a nail 14 (FIG. 2) extended through underlay 100 when attaching underlay 100 to a roofing substrate 16 (FIGS. 1, 2 and 5) of the roofing structure 10. In an aspect, underlay 100 can be a membrane comprising of a non-woven main layer having a thickness of at least about 180 microns (or 0.18 mm) in which the entangled filaments or fibers of the main layer forms a grip around the individual nails to prevent water from passing through the membrane. In an aspect, the thickness of the main layer can be in the range of 180 micron to 360 microns (±15%). The main layer can be a synthetic nonwoven fabric, for example, that comprises continuous fibers compressed between two other layers to form a multi-layer membrane. The fibers within the main layer act as channels for water molecules via capillary action, impeding water passage and providing the nail-sealability to the final roofing structure 10.

FIG. 1 illustrates a cross-section of underlay 100 and shows underlay 100 positioned between roofing overlay 12 and roofing substrate 16. FIG. 2 illustrates a portion of underlay 100 as fastened to roofing substrate 16 via fasteners, such as nails 14. Roofing overlay 12 may be any type of conventional overlay, such as shingles, flashing, tiles, and the like. Roofing substrate 16 may be any type of roofing substrate or surface decking, such as plywood, and the like. Fasteners, such as nails 14 (FIG. 2), and the like, can be used to fasten the underlay 100 to roofing substrate 16.

In general, underlay 100 may comprise a main layer 102, an anti-slip layer 104, and an anti-skid layer 106, where the main layer 102 is positioned between anti-slip layer 104 and anti-skid layer 106. A bonding layer 108 may be provided between main layer 102 and anti-slip layer 104. Anti-slip layer 104 can be a top layer that is configured to engage roofing overlay 12 and anti-skid layer 106 can be a bottom layer that is configured to engage roofing substrate 16.

Main layer 102 of underlay 100 can be formed of a fibrous non-woven material that may comprise a plurality of continuous randomly oriented entangled filaments or fibers 110, as seen in FIG. 1. FIG. 3 shows a segment of an exemplary fibrous non-woven material of main layer 102. Main layer 102 may include a first surface 112, which can be a top surface, an opposite second surface 114, which can be a bottom surface, and a thickness T. Thickness T may be at least about 180 microns, for example, or thickness T can be in the range of about 180 micron to 360 microns (±15%). Thickness T of main layer can make up about 75-80% of the entire thickness of underlay 100. The fibrous non-woven material of main layer 102 can be a thermoplastic non-woven fabric, for example. The thermoplastic non-woven fabric can be an embossed polypropylene spunbond fabric, for example. Spunbond fabric are produced by depositing extruded polyolefin material, continuous spun filaments onto a collecting belt in a random manner followed by bonding the fibers through calendaring process. The embossed polypropylene spunbond fabric can be a single or double beam fabric. Double beam uses two extruder system or double spinning beam system. The plurality of continuous randomly oriented entangled filaments 110 of main layer 102 are configured to grip a nail, such as nails 14, extended through underlay 100.

Anti-slip layer 104 can be bonded to the first surface 112 of main layer 102 and may comprise an anti-slip surface 116. Anti-skid layer 106 can be bonded to the second surface 114 of main layer 102 and may comprise anti-skid additives. The anti-skid additives may be any known anti-skid additive such as, semi-crystalline copolymers with tunable amorphous content or elastomers. Main layer 102 may be compressed between anti-slip layer 104 and anti-skid layer 106 to create a nail-sealable waterproof membrane 120 via capillary action of the continuous randomly oriented entangled filaments 110 of main layer 102. Capillary action or wicking is a physical process in which liquid flows without the help of gravity.

Anti-slip layer 104 may be a polymer fabric, e.g. polypropylene, spunbond fabric, such as an embossed fabric for improved traction, that may have UV stabilizers or additives. Anti-slip layer 104 may be bonded to the first surface 112 of main layer 102 via bonding layer 108. In an example, bonding layer 108 can be a lamination coating made of a polymeric material, such as polyolefin. Bonding layer 108 may include UV stabilizers or additives. Anti-skid layer 106 may be a coating with anti-skid additives and can be applied to the second surface 114 of main layer 102. Anti-skid layer 106 may be polymeric coating, for example, that is an extrusion coating of polyolefin material with additives to provide anti-skid properties.

Underlay 100 can be devoid of adhesive and asphalt and, as such, can be lighter in weight than conventional underlays. For example, underlay 100 may be about 245 to 360 grams per square meter (GSM) or about 5.73 pound per 100 square feet in weight.

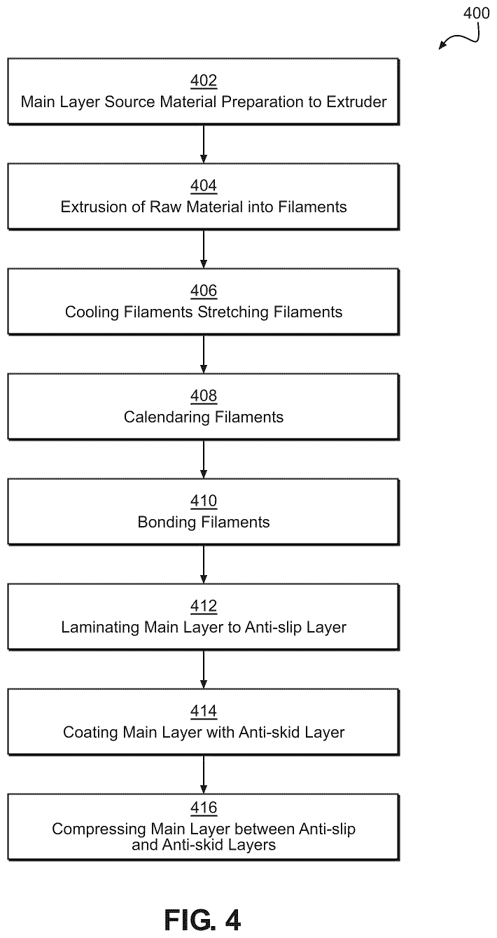

FIG. 4 is a flowchart of exemplary steps of an exemplary method 400 of manufacturing underlay 100. In general, the method 400 may comprise extruding a source material, such as a polymer material, to the form continuous filaments 110 of polymeric material (at step 404) that forms main layer 102 in which the continuous filaments 110 are oriented in a random manner; bonding the continuous filaments 110 to form main layer 102 (at step 410); laminating anti-slip layer 104 to the first surface 112 of main layer 102 (at step 412); coating anti-skid layer 106 to the second surface 114 of main layer 102 (at step 414); and compressing main layer 102 between anti- slip layer 104 and anti-skid layer 106 to create the nail-sealable waterproof membrane 120 via capillary action of the continuous randomly oriented entangled filaments 110 of main layer 102 (at step 416). In an aspect, main layer 102 can be compressed between the anti-slip and anti-skid layers 104 and 106 after the laminating and coasting at steps 412 and 414.

The method 400 of manufacturing underlay 100 may also include providing and preparing the source material for extrusion (at step 402). Raw material (such as thermoplastic polymer resin pellets) can be fed into the extruders. The thermoplastic polymer resin can comprise polypropylene, polyethylene, polyester or nylon, for example. The method 400 may also include cooling and stretching the filaments 110 of main layer 102 before orienting the filaments 110 in a random manner (at step 406). The filaments can be rapidly cooled by quenching air to solidify the filaments. The filaments can be stretched to orient molecules and improve strength. The steps of laminating anti-slip layer 104 on main layer 102 and coating main layer 102 with anti-skid layer 106 can be done separately or substantially simultaneously. In an aspect, main layer 102 can be extruded to have a thickness of at least about 180 microns. In an aspect, the method 400 of manufacturing underlay 100 can be done with using or applying adhesive or asphalt such that underlay 100 is devoid of adhesive and asphalt.

In one example, the nonwoven fabric of main layer 102 is formed by extruding the thermoplastic polymer resin through a spinneret die onto a moving belt in a random manner to form a sheet made of randomly oriented entangled filaments 110. The spinneret die can be a metal plate with many small holes through which a melt is pulled and/or forced to extrude filaments. The sheet can then be calendared between a pair of heated rolls to bond the filaments. One the heated rolls can be an engraved roll to produce a calendared sheet. The heated rolls are heated to a certain temperature and exert a pressure on main layer 102 sufficient to form bonded sheet of 180 micron (±15%) thickness. The calendar rolls can be maintained at different temperatures. The engraved roll can be maintained at a temperature between 148-160 degrees Celsius (±15%) and the smooth roll can be maintained at a temperature between 140-153 degrees Celsius (±15%). After calendaring, the finished product is a spunbond fabric in which filaments or fibers on the surface are boned while some of the filaments with the fabric are not bonded.

In an aspect, the underlay may further comprise a scrim reinforcement layer at the top with an anti-skid coating of a layer of nonwoven laminated or in between the main layer and an anti-slip coating at the bottom of the underlay. In an aspect, underlay 100 may have a minimum adhesive coating limited for ease of operation to the installer.

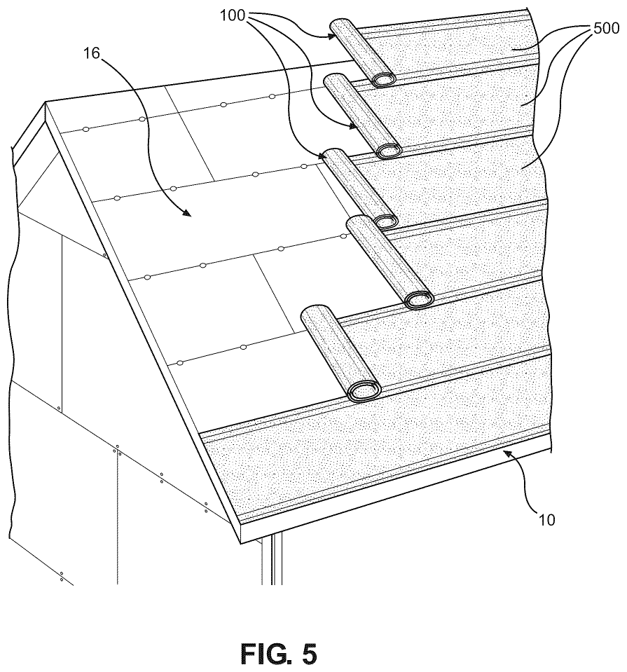

In an aspect, underlay 100 can be provided as panels 500 that are delivered to a construction site in bundled rolls, transferred to the roof, and then unrolled and positioned on the roofing substrate (or deck) 16, as seen in FIG. 5. The panels 500 can have a width, for example, of about 36 inches to about 63 inches and any desired length. Underlay 100 can then be affixed to the roofing substrate 16 of the building structure by employing varying techniques, such as mechanical fastening using nails 14 (FIG. 2).

The roofing substrate 16 to which underlay 100 is secured can be made of plywood and may include insulation or recover board, and/or an existing membrane. Underlay 100 can be secured to roofing substrate 16 to prevent wind uplift of the underlay panels 500, together with the roofing overlay 12 (FIG. 1) and other accessories, which can be positioned and adjoined to achieve a waterproof barrier on the roof. When installing underlay 100, edges of adjoining panels 500 can be overlapped, and these overlapping portions can be adjoined to one another in any known manner. One approach can be providing adhesives or adhesive tapes between the overlapping portions, thereby creating a water-resistant seal.

### ASTM D1970/D1970M-21

Underlay 100 meets the requirements of nail-sealability as set forth in ASTM D1970/D1970M-21 (Standard Specification for Self-Adhering Modified Bituminous Sheet Materials Used as Steep Roofing Underlayment for Ice Dam Protection). The following provides the testing conditions of sealability around nail conducted on underlay 100 per ASTM D1970/D1970M-21 and the passing result.
Conditioning: The test specimen materials of underlay 100 were held in standard laboratory conditions for at least 48 hours at a temperature of 23±2° C. (73.4±4° F.) and relative humidity of 50±5%. Time/Temp/RH: 9:00 AM/22.1° C./50.0%.
Test Duration: Maintained at 4° C. for 3 days.
Equipment: T&D TR-72Ui Temperature and Humidity Logger; Lunaire Environmental Chamber; Fluke 52II Thermometer; Omega Sheathed Thermocouple; and Stanley Tape Measure.
Sealability Around Nail (Head of Water Test): Sealability around nail (head of water test) was conducted as per Section 7.9 of ASTM D1970/D1970M-21 with reference to ASTM D7349/D7349M-15 (2019), Standard Test Method for Determining the Capability of Roofing and Waterproofing Materials to Seal around Fasteners. Testing was conducted using Protocol 4. Two (2) 300 mm by 300 mm (12 in.×12 in.) underlayment sheets of underlay 100 were cut and centered on a piece of 12 mm ( 15/32 in.) minimum thick (APA Rated, Exposure 1) plywood. A 75 mm×75 mm (3 in.×3 in.) single-thickness piece of ASTM D3462-labelled asphalt shingle material was placed on top of the test specimen. Two (2) 32 mm (1.25 in.) galvanized smooth shank steel roofing nails, 25 to 51 mm (1 to 2 in.) apart, were driven near the center of the plywood so that the nail heads were flush with the surface of the sheet of underlay 100. A bottom of a 4 L can was cut out and centered, bottom side down, on the membrane of underlay 100. Sealant was applied around the outside and also the inside of the rim of the can to bond to the membrane. The can, after 24 h at ambient temperature, was filled with water to a depth of 125±6 mm (5±0.25 in.) with distilled water. The entire assembly was placed in a refrigerator at 4±2° C. (39.2±3.6° F.) for a period of 72±0.25 hours. A visual inspection of the water in the bottom can, on the nail shanks, on the underside of the plywood, under the intervening material, and between the plywood and the underlayment sheet of underlay 100 was made. Both specimens of underlay 100 passed showing no water leakage after 72 hours on the plywood surface with the roofing nails.

It will be apparent to those skilled in the art having the benefit of the teachings presented in the foregoing descriptions and the associated drawings that modifications, combinations, sub-combinations, and variations can be made without departing from the spirit or scope of this disclosure. Likewise, the various examples described may be used individually or in combination with other examples. Those skilled in the art will appreciate various combinations of examples not specifically described or illustrated herein that are still within the scope of this disclosure. In this respect, it is to be understood that the disclosure is not limited to the specific examples set forth and the examples of the disclosure are intended to be illustrative, not limiting.

As used in this specification and the appended claims, the singular forms “a”, “an” and “the” include plural referents, unless the context clearly dictates otherwise. Similarly, the adjective “another,” when used to introduce an element, is intended to mean one or more elements. The terms “comprising,” “including,” “having” and similar terms are intended to be inclusive such that there may be additional elements other than the listed elements.

Additionally, where a method described above or a method claim below does not explicitly require an order to be followed by its steps or an order is otherwise not required based on the description or claim language, it is not intended that any particular order be inferred. Likewise, where a method claim below does not explicitly recite a step mentioned in the description above, it should not be assumed that the step is required by the claim.

It is noted that the description and claims may use geometric or relational terms, such as right, left, above, below, upper, lower, top, bottom, linear, arcuate, elongated, parallel, perpendicular, etc. These terms are not intended to limit the disclosure and, in general, are used for convenience to facilitate the description based on the examples shown in the figures. In addition, the geometric or relational terms may not be exact. For instance, walls may not be exactly perpendicular or parallel to one another because of, for example, roughness of surfaces, tolerances allowed in manufacturing, etc., but may still be considered to be perpendicular or parallel.

What is claimed is:

1. A roofing underlay, comprising:
a main layer formed of a fibrous non-woven material comprising a plurality of continuous randomly oriented entangled fibers;
an anti-slip layer bonded to a first surface of the main layer, the anti-slip layer comprising an anti-slip surface; and
an anti-skid layer bonded to a second surface of the main layer, the anti-skid layer comprising anti-skid additives,
wherein the main layer is compressed between the anti-slip layer and the anti-skid layer to create a nail-sealable waterproof membrane via capillary action of the continuous randomly oriented entangled fibers of the main layer.

2. The roofing underlay of claim 1, wherein the fibrous non-woven material is a thermoplastic non-woven fabric.

3. The roofing underlay of claim 2, wherein the thermoplastic non-woven fabric is an embossed double beam polypropylene spunbond fabric.

4. The roofing underlay of claim 1, wherein a thickness of the main layer is at least about 180 microns.

5. The roofing underlay of claim 1, wherein a thickness of the main layer is about 75-80% of an entire thickness of the roofing underlay.

6. The roofing underlay of claim 1, wherein the plurality of continuous randomly oriented entangled fibers of the main layer are configured to grip a nail extended therethrough.

7. The roofing underlay of claim 1, further comprising a bonding layer between the anti-slip layer and the first surface of the main layer.

8. The roofing underlay of claim 7, wherein the bonding layer is a polymeric coating.

9. The roofing underlay of claim 1, wherein the roofing underlay is devoid of asphalt or adhesive.

10. The roofing underlay of claim 1, wherein the roofing underlay is about 245 to 360 GSM.

11. A roofing underlay, comprising:
a main layer formed of a fibrous non-woven fabric comprising a plurality of continuous randomly oriented entangled fibers, the main layer having a first surface, a second surface, and a thickness being at least about 180 microns;
an anti-slip layer formed of an embossed fabric comprising an anti-slip surface, the anti-slip layer being bonded to the first surface of the main layer by a bonding layer that is a lamination coating; and
an anti-skid layer comprising anti-skid additives that is applied to the second surface of the main layer,
wherein the main layer is compressed between the anti-slip layer and the anti-skid layer to create a nail-sealable waterproof membrane via capillary action of the continuous randomly oriented entangled fibers of the main layer.

12. The roofing underlay of claim 11, wherein the fibrous non-woven fabric is an embossed double beam polypropylene spunbond fabric.

13. The roofing underlay of claim 11, wherein the roofing underlay is devoid of adhesive or asphalt.

14. The roofing underlay of claim 11, wherein the anti-skid layer is configured to engage a roofing substrate and the anti-slip layer is configured to engage a roofing overlay.

15. A method of manufacturing a roofing underlay, the method comprising:
extruding a polymer source material to form continuous filaments of polymeric material that forms a main layer in which the continuous filaments are oriented in a random manner;
laminating an anti-slip layer to a first surface of the main layer, the anti-slip layer comprising an anti-slip surface;
coating an anti-skid layer to a second surface of the main layer, the anti-skid layer comprising an anti-skid additives; and
compressing the main layer between the anti-slip layer and the anti-skid layer to create a nail-sealable waterproof membrane via capillary action of the continuous randomly oriented fibers of the main layer.

16. The method of claim 15, wherein forming the main layer includes cooling and stretching the continuous filaments before orienting the continuous filaments in a random manner.

17. The method of claim 15, wherein laminating the anti-slip layer on the main layer and coating the anti-skid layer to the main layer are done substantially simultaneously.

18. The method of claim 15, wherein the polymer source material is polypropylene and the polymeric material is an embossed double beam polypropylene spunbond fabric.

19. The method of claim 15, wherein the main layer has a thickness of at least about 180 microns.

20. The method of claim 15, wherein the roofing underlay is devoid of adhesive or asphalt.
